(19) United States
(12) Patent Application Publication
(10) Pub. No.: US 2017/0255352 A1
(43) Pub. Date: Sep. 7, 2017

(54) ELECTRONIC DEVICE

(71) Applicant: KYOCERA CORPORATION, Kyoto (JP)

(72) Inventor: Shiro OMASA, Yokohama-shi (JP)

(21) Appl. No.: 15/604,467

(22) Filed: May 24, 2017

Related U.S. Application Data
(63) Continuation of application No. PCT/JP2015/083262, filed on Nov. 26, 2015.

(30) Foreign Application Priority Data
Nov. 26, 2014 (JP) 2014-238813

(51) Int. Cl. G06F 3/0482; G06K 9/32; G06F 3/0488; G06K 9/18

(52) U.S. Cl. CPC G06F 3/0482; G06K 9/18; G06K 9/3233; G06F 3/04883

(57) ABSTRACT

At least one processor extracts one or more characters included in an image presented on a display without the user's operation, and stores the characters in a memory. At least one processor transfers the extracted characters to a location specified by the user, based on the character information stored in the memory.

### CROSS-REFERENCE TO RELATED APPLICATION

The present application is a continuation based on PCT Application No. PCT/JP2015/083262 filed on Nov. 26, 2015, which claims the benefit of Japanese Application No. 2014-238813, filed on Nov. 26, 2014. PCT Application No. PCT/JP2015/083262 is entitled “Electronic Instrument”, and Japanese Application No. 2014-238813 is entitled “Electronic Device”. The content of which are incorporated by reference herein in their entirety.

### FIELD

The present disclosure relates to an electronic device.

### BACKGROUND

Conventionally, an electronic device such as a mobile terminal has had a function of copying a displayed character or characters by a user's operation and transferring the character or characters copied by the user's operation to another location.

### SUMMARY

An electronic device in one embodiment includes: a display; a touch panel configured to accept a user's input operation; a memory configured to store a character;

and at least one processor. The at least one processor is configured to extract one or more characters included in an image presented on the display, without the user's input operation through the touch panel, and store the one or more characters in the memory. The at least one processor is configured to present the one or more characters stored in the memory on the display as transfer candidates, and transfer, to a specified location, one or more characters selected based on the user's input operation through the touch panel.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram showing a hardware configuration of an electronic device in an embodiment.

FIG. 2 is a block diagram showing functions implemented by at least one processor executing an application program and a character input processing program.

FIG. 3 is a flowchart showing an operation procedure of character copying and transferring in the embodiment.

FIG. 4 is a flowchart showing a procedure of the character copy processing in a first embodiment.

FIG. 5 is a diagram for describing a specific example of the character copy processing in the first embodiment.

FIG. 6 is a diagram for describing the specific example of the character copy processing in the first embodiment.

FIG. 7 is a diagram for describing the specific example of the character copy processing in the first embodiment.

FIG. 8 is a diagram for describing the specific example of the character copy processing in the first embodiment.

FIG. 9 is a diagram for describing the specific example of the character copy processing in the first embodiment.

FIG. 10 is a flowchart showing a procedure of the character transfer processing in the first embodiment.

FIG. 11 is a diagram showing an example of a standard keypad.

FIG. 12 is a diagram showing an example of a transfer keypad in the first embodiment.

FIG. 13 is a diagram for describing the character transfer operation by the transfer keypad in a modification of the first embodiment.

FIG. 14 is a flowchart showing a procedure of the character copy processing in a second embodiment.

FIGS. 15A and 15B are diagrams for describing a specific example of the character copy processing in the second embodiment.

FIGS. 16A and 16B are diagrams for describing the specific example of the character copy processing in the second embodiment.

FIG. 17 is a flowchart showing a procedure of the character transfer processing in the second embodiment.

FIG. 18 is a diagram showing an example of a transfer keypad in the second embodiment.

FIG. 19 is a diagram showing an example of a transfer keypad in the second embodiment.

FIG. 20 is a diagram showing an example of pieces of image extraction character information stored in a memory.

FIG. 21 is a flowchart showing a procedure of the character copy processing in a third embodiment.

FIG. 22 is a flowchart showing a procedure of the character transfer processing in the third embodiment.

FIG. 23 is a diagram for describing an example of characters displayed by switching of a transfer keypad in the third embodiment.

FIG. 24 is a flowchart showing a procedure of the character transfer processing in a fourth embodiment.

FIG. 25 is a diagram showing an example of a transfer keypad in the fourth embodiment.

FIG. 26 is a diagram for describing an example of characters displayed by switching of the transfer keypad in the fourth embodiment.

FIG. 27 is a flowchart showing a procedure of the character copy processing in a fifth embodiment.

FIG. 28 is a diagram for describing a specific example of the character copy processing in the fifth embodiment.

FIGS. 29A and 29B are diagrams for describing a specific example of the character copy processing in the fifth embodiment.

FIG. 30 is a diagram showing an example of a transfer keypad in the fifth embodiment.

FIG. 31 is a diagram showing an example of a transfer keypad in the fifth embodiment.

FIG. 32 is a flowchart showing a procedure of the character copy processing in a sixth embodiment.

### DETAILED DESCRIPTION

Embodiments will be described hereinafter with reference to the drawings.

In an electronic device such as a mobile terminal, copying of a character or characters by a user's operation may be troublesome in some cases. For example, a mobile terminal such as a smart phone has a small-sized display, and thus, it is not easy to select and copy a character or characters. The foregoing problem can be solved by the following disclosure.

### First Embodiment

Conventional copying and transferring in an electronic device such as a mobile terminal are performed in accordance with the following procedure.

(1) The user specifies a start point of a character string to be copied in a displayed image.

(2) The user specifies an end point of the character string to be copied in the displayed image.

(3) The user provides, to the electronic device, an instruction to perform character copying. Normally, a copy button is displayed after the user selects the end point of the character string to be copied.

(4) The user renders active an area where the copied character string is used.

(5) The user provides, to the electronic device, an instruction to perform character transferring. Normally, the user selects transfer from a menu button displayed by pressing the target area for a long time.

As compared with a stationary information terminal such as a personal computer, a mobile terminal typified by a smart phone does not have a dedicated input device such as a keyboard and a mouse. In such mobile terminal, in order to specify a start point and an end point of a character string to be copied in an image presented on a display, the user must tap a position corresponding to the start point of the character string on a touch panel, and drag the user's fingertip to a position corresponding to the end point of the character string.

As the size of the mobile terminal becomes smaller, the size of the display and the touch panel also becomes smaller. Therefore, such tapping and dragging operation with the user's fingertip becomes the elaborate work.

A character string handled by copying and transferring must be a consecutive character string. For example, only the character string of AACC in the character string of AABBCC cannot be simply copied and transferred. Namely, it is necessary to copy and transfer AABBCC, and then, move a cursor and delete BB.

Furthermore, the number of character strings that can be stored by copying is always one and a plurality of character strings cannot be stored. Namely, the previously copied character string is deleted by the copy operation.

The present disclosure solves the foregoing problem.

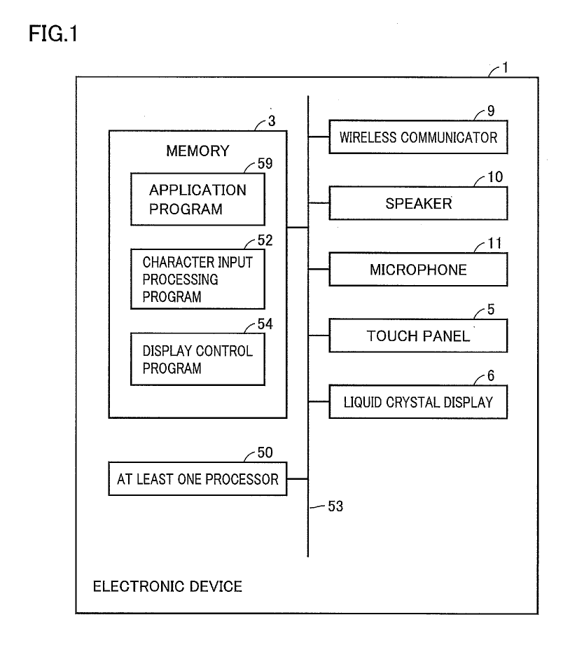

FIG. 1 is a diagram showing a hardware configuration of an electronic device in an embodiment.

Referring to FIG. 1, an electronic device 1 is a mobile terminal such as a smart phone, and includes a touch panel 5, a liquid crystal display 6, a memory 3, a wireless communicator 9, a speaker 10, a microphone 11, at least one processor 50, and a bus 53. Memory 3 can store programs such as an application program 59, a character input processing program 52 and a display control program 54 as well as various types of data. At least one processor 50 can control the whole of electronic device 1.

According to various embodiments, at least one processor 50 may be implemented as a single integrated circuit (IC), or may be implemented as a plurality of communicatively connected integrated circuits (ICs) and/or discrete circuits. At least one processor 50 can be implemented in accordance with various known techniques.

In an embodiment, at least one processor 50 includes one or more circuits or units configured to execute one or more data calculation procedures or processes. For example, at least one processor 50 may include one or more processors, controllers, microprocessors, microcontrollers, application specific integrated circuits (ASICs), digital signal processing devices, programmable logic devices, field programmable gate arrays, or an arbitrary combination of these devices or configurations, or a combination of other known devices and configurations, and may execute the function described below.

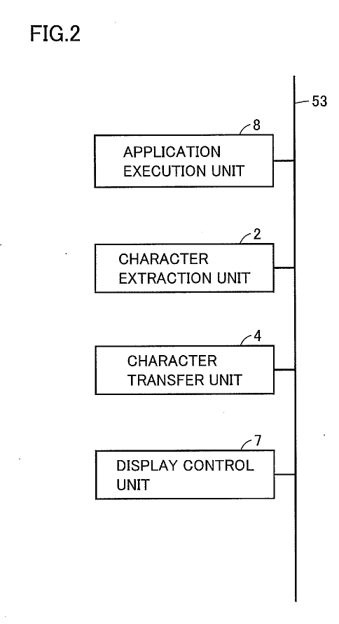

FIG. 2 is a block diagram showing functions implemented by at least one processor 50 executing application program 59, character input processing program 52 and display control program 54.

An application execution unit 8 is implemented by at least one processor 50 executing application program 59. A character extraction unit 2 and a character transfer unit 4 are implemented by at least one processor 50 executing character input processing program 52. A display control unit 7 is implemented by at least one processor 50 executing display control program 54.

Speaker 10 can output a sound reproduced by application execution unit 8, a voice of the other person on the phone, and the like.

An outside sound such as a user's voice can be input to microphone 11.

Application execution unit 8 can execute various types of applications.

Liquid crystal display 6 can present a result of execution by application execution unit 8 and the like. Display control unit 7 can control the presentation of liquid crystal display 6. Liquid crystal display 6 can also be replaced with another display, e.g., an organic EL display that can present information.

Touch panel 5 can accept an input from the user.

Wireless communicator 9 can perform wireless communication with a not-shown wireless base station.

Character extraction unit 2 can extract and copy one or more characters included in an image presented on liquid crystal display 6, without a user's operation, and create image extraction character information, and store the image extraction character information in memory 3. Specifically, the image extraction character information refers to a character code for identifying the one or more characters extracted from the image.

Based on the image extraction character information stored in memory 3, character transfer unit 4 can transfer the copied characters to a location specified by the user.

Character extraction unit 2 and character transfer unit 4 can be implemented, for example, by at least one processor 50 executing the programs stored in memory 3.

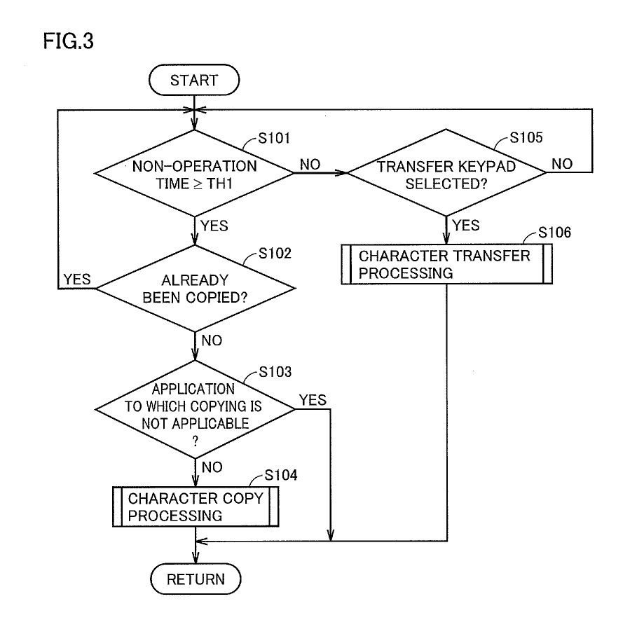

FIG. 3 is a flowchart showing an operation procedure of character copying and transferring in the embodiment. The processing of this flowchart may be executed, every time an image presented on liquid crystal display 6 of electronic device 1 is switched.

Referring to FIG. 3, in step S101, if a duration in which the user does not operate the electronic device (hereinafter referred to as “non-operation time”) is not less than a threshold value TH1, the processing proceeds to step S102. If the non-operation time is less than threshold value TH1, the processing proceeds to step S105.

In step S102, if one or more characters have already been copied from an image displayed in the forefront, the processing returns to step S101. If the one or more characters are not yet copied from the image displayed in the forefront, the processing proceeds to step S103.

In step S103, if an application presenting the image displayed in the forefront is an application to which copying is not applicable, the processing returns to step S101. If the application presenting the image displayed in the forefront is not the application to which copying is not applicable, the processing proceeds to step S104. The application to which copying is not applicable can be selected by the user. For example, the user can set a bank account management application as the application to which copying is not applicable, and thereby can set the characters indicating a bank account number, an amount of money or uses such that they cannot be copied.

In step S104, character extraction unit 2 can extract one or more characters included in the image displayed in the forefront, create image extraction character information for identifying the extracted one or more characters, and store the image extraction character information in memory 3.

In step S105, if the user selects a transfer keypad described below, the processing proceeds to step S106.

In step S106, character transfer unit 4 can transfer one or more characters specified by the user, of the one or more characters identified by the image extraction character information stored in memory 3, to a region specified by the user.

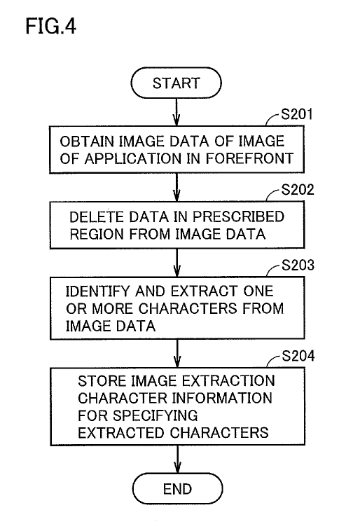

FIG. 4 is a flowchart showing a procedure of the character copy processing in a first embodiment. FIGS. 5 to 9 are diagrams for describing a specific example of the character copy processing in the first embodiment.

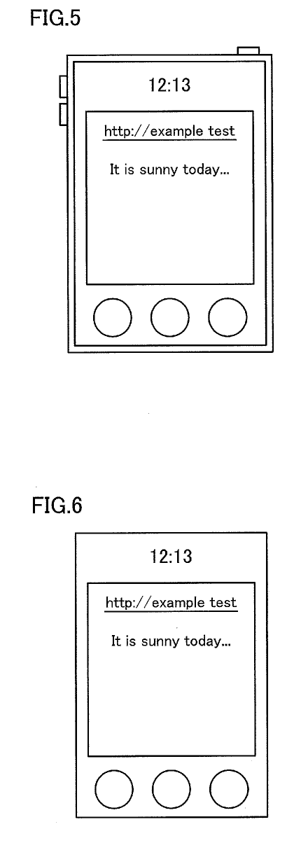

Referring to FIG. 4, in step S201, character extraction unit 2 obtains image data of an image displayed in the forefront. For example, when an image is displayed on electronic device 1 as shown in FIG. 5, image data of the image in the forefront as shown in FIG. 6 is obtained.

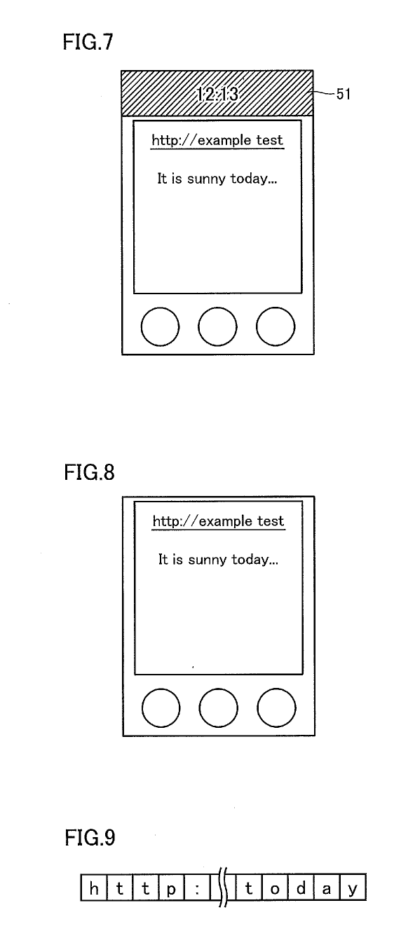

In step S202, character extraction unit 2 can delete data in a prescribed region from the obtained image data. For example, a prescribed region 51 shown in FIG. 7 is deleted from the image data shown in FIG. 6, and image data shown in FIG. 8 is thereby obtained.

In step S203, in accordance with a character recognition algorithm, character extraction unit 2 can identify and extract one or more characters included in the image data from which the data in the prescribed region was deleted.

In step S204, character extraction unit 2 can store, in memory 3, image extraction character information for identifying the extracted one or more characters. FIG. 9 is a diagram showing an example of the characters identified by the image extraction character information stored in memory 3.

In the first embodiment, the previously extracted image extraction character information can be erased and only the newest image extraction character information can be stored. Therefore, only the characters extracted from the newest image can be transferred.

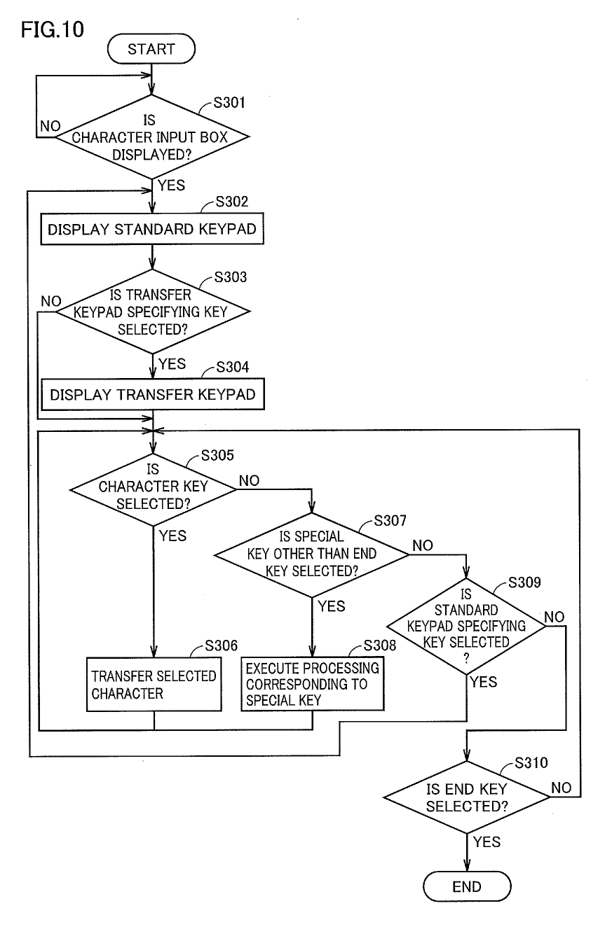

FIG. 10 is a flowchart showing a procedure of the character transfer processing in the first embodiment.

In step S301, if a character input box is displayed by a user's operation, the processing proceeds to step S302.

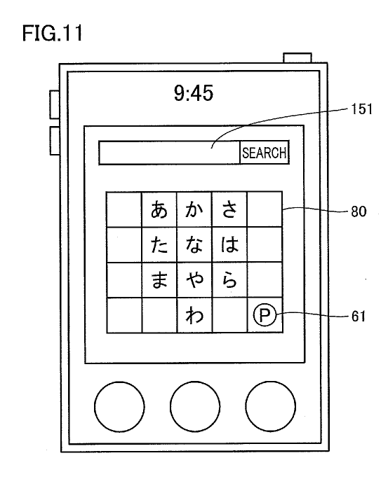

In step S302, character transfer unit 4 can display a standard keypad. For example, as shown in FIG. 11, a character input box 151 and a standard keypad 80 are displayed. Standard keypad 80 includes a transfer keypad specifying key 61.

In step S303, if the transfer keypad specifying key is selected by a user's operation of tapping touch panel 5, the processing proceeds to step S304.

In step S304, character transfer unit 4 can display the transfer keypad. The transfer keypad includes one or more character keys (character key group) identified by the image extraction character information stored in memory 3 by character extraction unit 2, and one or more special keys (special key group).

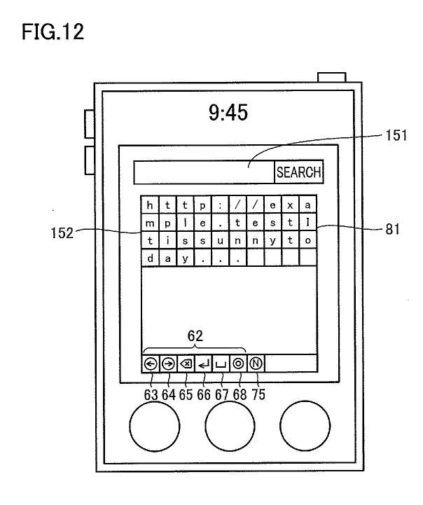

For example, a transfer keypad 81 shown in FIG. 12 is displayed. This transfer keypad 81 includes a character key group 152 and a special key group 62. Special key group 62 includes a leftward movement key 63, a rightward movement key 64, a deletion key 65, a line feed key 66, a space key 67, and an end key 68, as well as a standard keypad specifying key 75.

In step S305, if a character key in the standard keypad or the transfer keypad is selected by a user's input operation to touch panel 5, and specifically by a user's tapping operation (operation of tapping touch panel 5 with the finger), the processing proceeds to step S306.

In step S306, character transfer unit 4 can transfer a character corresponding to the selected character key (character at a position of input to touch panel 5) to the character input box. For example, in FIG. 11, when the position of input to touch panel 5 is a position of a character P, character P is transferred to character input box 151.

In step S307, if a special key other than the end key in the standard keypad or the transfer keypad is selected by the user's input operation to touch panel 5, and specifically by the user's tapping operation, the processing proceeds to step S308.

In step S308, character transfer unit 4 can execute the processing corresponding to the special key. For example, when leftward movement key 63 is selected, the cursor moves back by one character. When rightward movement key 64 is selected, the cursor moves forward by one character. When deletion key 65 is selected, a character on the cursor is erased. When line feed key 66 is selected, a new line starts. When space key 67 is selected, a space (blank character) is input.

In step S309, if the standard keypad specifying key is selected by the user's input operation to touch panel 5, and specifically by the user's tapping operation, the processing returns to step S302. For example, when standard keypad specifying key 75 shown in FIG. 12 is selected, the processing returns to step S302 and standard keypad 80 shown in FIG. 11 is displayed.

In step S310, if the end key is selected by the user's input operation to touch panel 5, and specifically by the user's tapping operation, the processing ends. For example, when end key 68 shown in FIG. 12 is selected, character copying ends.

As described above, according to the first embodiment, the character string can be automatically copied without the user's tapping and dragging operation on the touch panel. In the first embodiment, the operation of tapping the touch panel is required at the time of character transferring. However, by setting the characters displayed on the transfer keypad to have a size that allows the user to easily select the characters, the operation of tapping the touch panel cannot become the elaborate work.

Conventionally, in order to transfer only the character string of AACC in the character string of AABBCC to a specified region, the user has needed to copy AABBCC and transfer AABBCC to the specified region, and then, move the cursor and delete BB. In contrast, in the first embodiment, the user can transfer AACC by selecting the characters A, A, C, and C in the transfer keypad.

In the first embodiment, the user can copy all of the characters included in the displayed image, not one character string selected by the user as in the conventional art.

Furthermore, in the first embodiment, the image data is obtained from the displayed image, and the one or more characters included in the image data are extracted and copied in accordance with the character recognition algorithm. Therefore, a character included in an image such as a photograph, which could not be copied and transferred in the conventional art, can also be copied and transferred.

### [Modification of First Embodiment]

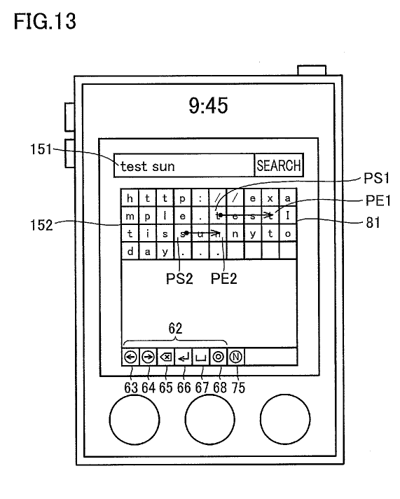

FIG. 13 is a diagram for describing the character transfer operation by the transfer keypad in a modification of the first embodiment.

When the user taps a start point (input start position) PS in a plurality of characters displayed on the transfer keypad and performs dragging to an end point (input end position) PE, character transfer unit 4 can select and transfer a character string located between the start point and the end point.

In FIG. 13, character transfer unit 4 first transfers a character string of “test” located between a start point PS1 and an end point PE1. Thereafter, character transfer unit 4 transfers a character string of “sun” located between a start point PS2 and an end point PE2. Character transfer unit 4 inputs a space (blank character) between the two character strings automatically (without a user's operation).

According to the present modification, the user's character transfer operation can be facilitated.

### Second Embodiment

In the first embodiment, only the image extraction character information for identifying one or more characters on the newest image is recorded in memory 3. In contrast, in a second embodiment, the image extraction character information for identifying one or more characters on the newest image and one or more pieces of image extraction character information for identifying one or more characters on a previous image can be stored in memory 3. The character transfer unit can preferentially display a transfer keypad including the characters on the new image.

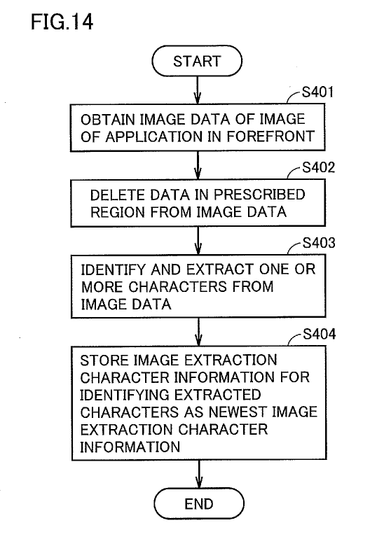

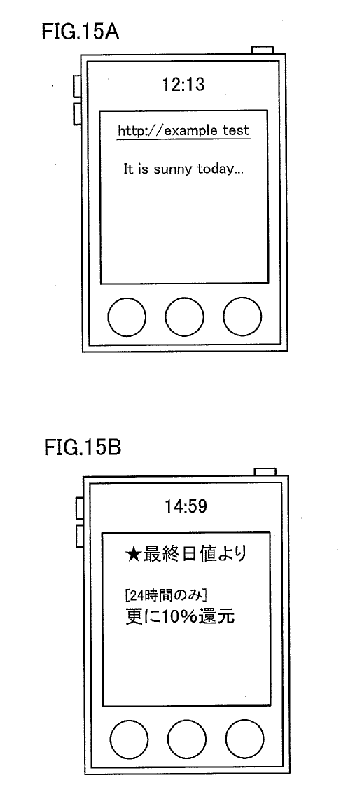

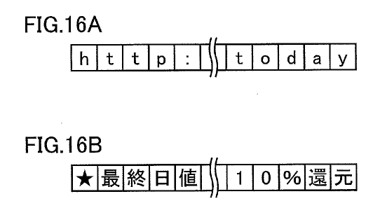

FIG. 14 is a flowchart showing a procedure of the character copy processing in the second embodiment. FIGS. 15A and 15B and FIGS. 16A and 16B are diagrams for describing a specific example of the character copy processing in the second embodiment.

Referring to FIG. 14, in step S401, character extraction unit 2 can obtain image data of an image displayed in the forefront.

In step S402, character extraction unit 2 can delete data in a prescribed region from the obtained image data.

In step S403, in accordance with the character recognition algorithm, character extraction unit 2 can identify and extract one or more characters included in the image data from which the data in the prescribed region was deleted.

In step S404, character extraction unit 2 can store, in memory 3, image extraction character information for identifying the extracted one or more characters as the newest image extraction character information.

FIG. 15A is a diagram showing an example of image data obtained from the newest image (also referred to as “current image” or “first newest image”) displayed in the forefront, as a result of the latest execution of step S401. FIG. 15B is a diagram showing an example of image data obtained from an image (second newest image) preceding by one the image displayed in the forefront, as a result of immediately preceding execution of step S401.

FIG. 16A is a diagram showing image extraction character information extracted from the image data of the image shown in FIG. 15A. FIG. 16B is a diagram showing image extraction character information extracted from the image data of the image shown in FIG. 15B.

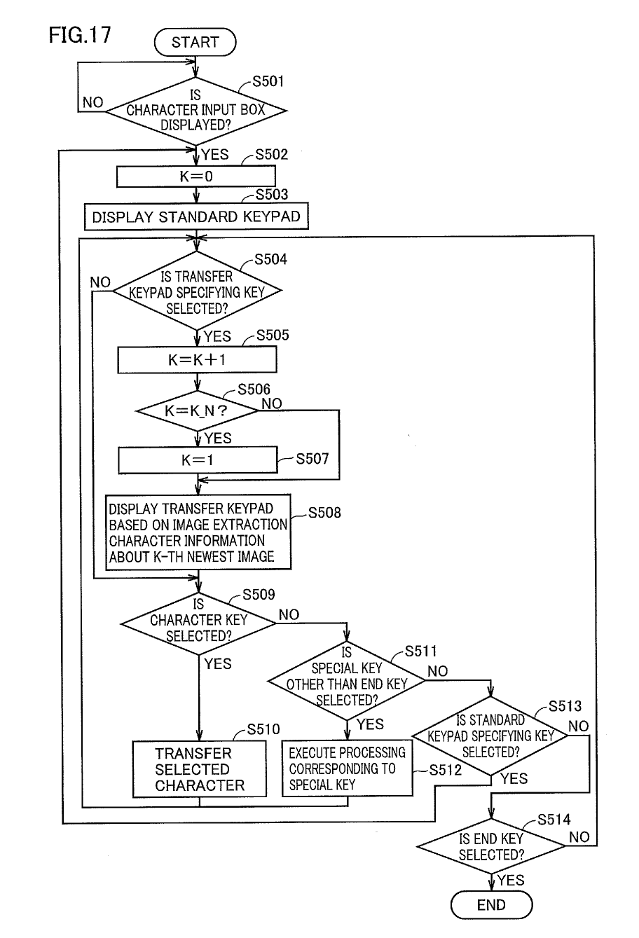

FIG. 17 is a flowchart showing a procedure of the character transfer processing in the second embodiment.

In step S501, if a character input box is displayed by a user's operation, the processing proceeds to step S502.

In step S502, a variable K where the characters on the K-th newest image is displayed is set at 0.

In step S503, character transfer unit 4 can display the standard keypad.

In step S504, if a transfer keypad specifying key is selected by a user's operation of tapping touch panel 5, the processing proceeds to step S505.

In step S505, variable K is incremented.

In step S506, if variable K is the number K_N of the image extraction character information, the processing proceeds to step S507. If variable K is not the number K_N of the image extraction character information, the processing proceeds to step S508.

The information about the number K_N is stored in memory 3, and is rewritten such that the number K_N increases in increments of one, every time the image extraction character information is stored in memory 3. In step S506, this number K_N is read from memory 3.

In step S508, character transfer unit 4 can display a transfer keypad based on image extraction character information about a K-th newest image. The transfer keypad includes one or more character keys (character key group) identified by the image extraction character information stored in memory 3 by character extraction unit 2, and one or more special keys (special key group).

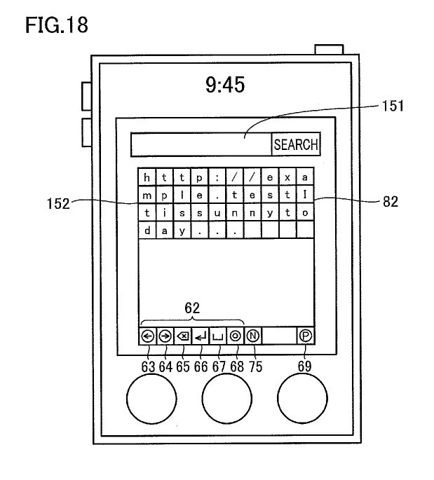

For example, when the current value of K is 1, a transfer keypad 82 shown in FIG. 18 is displayed. This transfer keypad 82 includes character key group 152, special key group 62 and a transfer keypad specifying key 69. The character keys included in character key group 152 are character keys extracted from the first newest image shown in FIG. 16A.

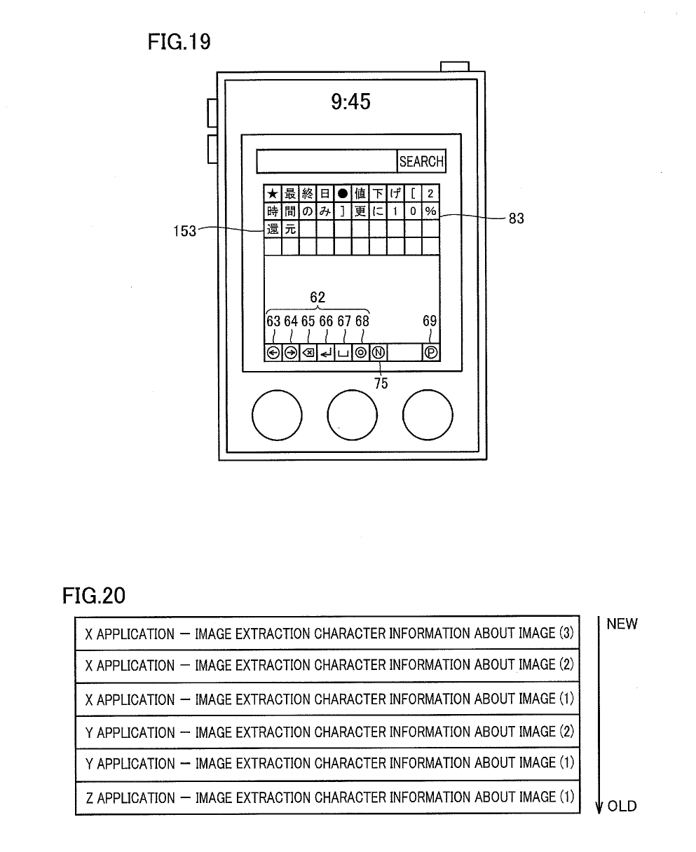

When transfer keypad specifying key 69 in transfer keypad 82 is selected, transfer keypad 82 being displayed as a result of the increment of K can be switched to a transfer keypad 83 for K=2. When the current value of K is 2, transfer keypad 83 shown in FIG. 19 is displayed. This transfer keypad 83 includes a character key group 153, special key group 62 and transfer keypad specifying key 69. The character keys included in character key group 153 are character keys extracted from the second newest image shown in FIG. 16B.

In step S509, if a character key in the standard keypad or the transfer keypad is selected by the user's operation of tapping touch panel 5, the processing proceeds to step S510.

In step S510, character transfer unit 4 can transfer a character corresponding to the selected character key to the character input box. Thereafter, the processing returns to step S504.

In step S511, if a special key other than the end key in the standard keypad or the transfer keypad is selected by the user's operation of tapping touch panel 5, the processing proceeds to step S512.

In step S512, character transfer unit 4 executes the processing corresponding to the special key. Thereafter, the processing returns to step S504.

In step S513, if the standard keypad specifying key is selected by the user's input operation to touch panel 5, and specifically by the user's tapping operation, the processing returns to step S502.

In step S514, if the end key is selected by the user's operation of tapping touch panel 5, the processing ends.

As described above, according to the second embodiment, it is possible to store the plurality of pieces of image extraction character information, and switch to any one of the plurality of pieces of image extraction character information in accordance with a user's instruction, and the transfer keypad including the characters identified by the switched image extraction character information is displayed. Thus, in the second embodiment, the character candidates to be transferred can be increased as compared with the first embodiment.

According to the second embodiment, one transfer keypad specifying key 69 is provided. However, two types of transfer keypad specifying keys 69, i.e., a transfer keypad specifying key 69a for switching to next transfer keypad 83 (incrementing variable K) and a transfer keypad specifying key 69b for switching to immediately preceding transfer keypad 83 (decrementing variable K), may be provided.

### Third Embodiment

In the second embodiment, even when the characters from the plurality of applications are copied, the transfer keypad including the characters identified by the image extraction character information about the most newly displayed image is first displayed regardless of the copy source applications.

FIG. 20 is a diagram showing an example of the pieces of image extraction character information stored in memory 3.

First, an image (1) of a Z application is displayed and the image extraction character information about this image is stored in memory 3. Thereafter, an image (1) of a Y application is displayed and the image extraction character information about this image is stored in memory 3. Thereafter, an image (2) of the Y application is displayed and the image extraction character information about this image is stored in memory 3. Thereafter, an image (1) of an X application is displayed and the image extraction character information about this image is stored in memory 3. Thereafter, an image (2) of the X application is displayed and the image extraction character information about this image is stored in memory 3. Thereafter, an image (3) of the X application is displayed and the image extraction character information about this image is stored in memory 3.

In the second embodiment, every time the user selects the transfer keypad specifying key at the time of character transferring, the transfer keypad including the characters from the image having new display order is displayed.

Specifically, every time the user selects the transfer keypad specifying key, a transfer keypad including one or more characters on the image (1) of the Z application, a transfer keypad including one or more characters on the image (1) of the Y application, a transfer keypad including one or more characters on the image (2) of the Y application, a transfer keypad including one or more characters on the image (1) of the X application, a transfer keypad including one or more characters on the image (2) of the X application, and a transfer keypad including one or more characters on the image (3) of the X application are displayed in order.

Therefore, in the second embodiment, the characters obtained from the same application may become transfer candidates continuously. On the other hand, the characters used in the application may be specific to the application. In such a case, even when the transfer keypad specifying key is selected, the transfer candidate characters cannot be easily found in some cases because the variety of characters in the character key group included in the transfer keypad is not so wide.

Therefore, it is desirable to switch the copy source application such that the copy source application of the transfer candidate characters is not the same application continuously.

In a third embodiment, character transfer unit 4 can switch the copy source application of the characters included in the transfer keypad, every time the user selects the transfer keypad specifying key.

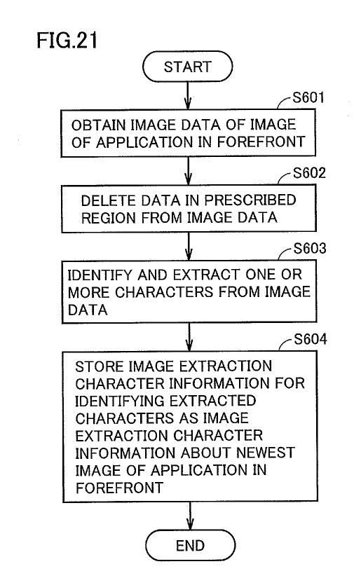

FIG. 21 is a flowchart showing a procedure of the character copy processing in the third embodiment.

Referring to FIG. 21, in step S601, character extraction unit 2 can obtain image data of an image displayed in the forefront.

In step S602, character extraction unit 2 can delete data in a prescribed region from the obtained image data.

In step S603, in accordance with the character recognition algorithm, character extraction unit 2 can identify and extract one or more characters included in the image data from which the data in the prescribed region was deleted.

In step S604, character extraction unit 2 can store, in memory 3, image extraction character information for identifying the extracted one or more characters as the image extraction character information about the newest image of the application in the forefront.

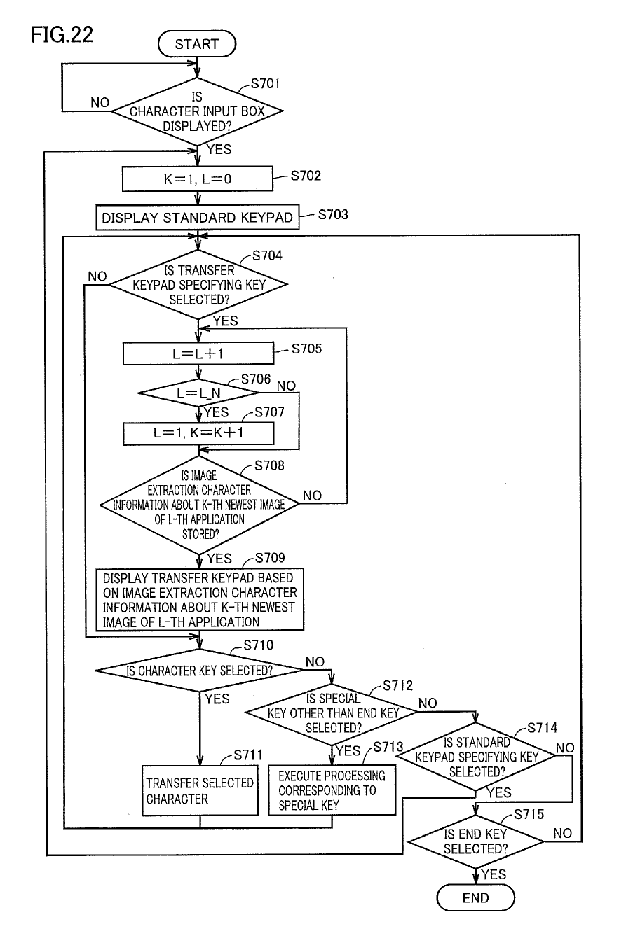

FIG. 22 is a flowchart showing a procedure of the character transfer processing in the third embodiment.

In the following description, a variable L (=1, 2, . . . ) is used to specify the application.

In step S701, if a character input box is displayed by a user's operation, the processing proceeds to step S702.

In step S702, variable K is set at 1 and variable L is set at 0.

In step S703, character transfer unit 4 can display the standard keypad.

In step S704, if the user selects the transfer keypad specifying key, the processing proceeds to step S705.

In step S705, variable L for switching the application is incremented. In step S706, if variable L is the number L_N of the applications, the processing proceeds to step S707. If variable L is not the number L_N of the applications, the processing proceeds to step S708.

The number L_N of the applications refers to the number of the applications storing the image extraction character information about at least one image. This information about the number L_N is stored in memory 3, and is rewritten such that the number L_N increases in increments of one, every time image extraction character information of a different application is stored in memory 3. In step S706, this number L_N is read from memory 3.

In step S707, variable L is set at 1 and variable K is incremented.

In step S708, if image extraction character information about a K-th newest image of an L-th application is stored in memory 3, the processing proceeds to step S709. If the image extraction character information about the K-th newest image of the L-th application is not stored in memory 3, the processing returns to step S705.

In step S709, character transfer unit 4 can display a transfer keypad based on the character information about the K-th newest image of the L-th application.

In step S710, if a character key in the standard keypad or the transfer keypad is selected by the user's operation of tapping touch panel 5, the processing proceeds to step S711.

In step S711, character transfer unit 4 transfers a character corresponding to the selected character key to the character input box. Thereafter, the processing returns to step S704.

In step S712, if a special key other than the end key in the standard keypad or the transfer keypad is selected by the user's operation of tapping touch panel 5, the processing proceeds to step S713.

In step S713, character transfer unit 4 executes the processing corresponding to the special key. Thereafter, the processing returns to step S704.

In step S714, if the standard keypad specifying key is selected by the user's input operation to touch panel 5, and specifically by the user's tapping operation, the processing returns to step S702.

In step S715, if the end key is selected by the user's operation of tapping touch panel 5, the processing ends.

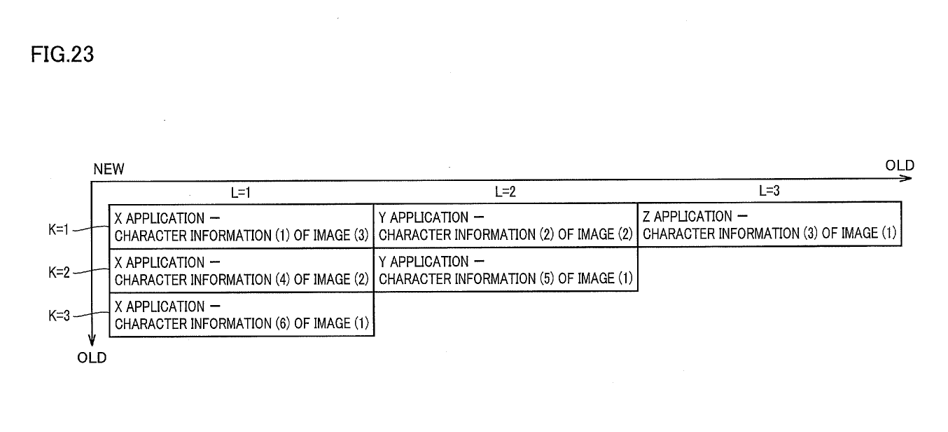

FIG. 23 is a diagram for describing the characters in the transfer keypads switched every time the transfer keypad specifying key is selected at the time of character transferring, when the character information shown in FIG. 20 is stored in memory 3.

First, when the current value of K is 1 and the current value of L is 1, a transfer keypad including the characters identified by the image extraction character information about the newest image (3) with K=1 of the X application with L=1 is displayed.

Thereafter, when the transfer keypad specifying key is selected, the value of L is incremented to 2. In this case, a transfer keypad including the characters identified by the image extraction character information about the newest image (2) with K=1 of the Y application with L=2 is displayed.

Thereafter, when the transfer keypad specifying key is selected, the value of L is incremented to 3. In this case, a transfer keypad including the characters identified by the image extraction character information about the newest image (1) with K=1 of the Z application with L=3 is displayed.

Thereafter, when the transfer keypad specifying key is selected, the value of L returns to 1 and the value of K is incremented to 2. In this case, a transfer keypad including the characters identified by the image extraction character information about the second newest image (2) with K=1 of the X application with L=1 is displayed.

Thereafter, when the transfer keypad specifying key is selected, the value of L is incremented to 2. In this case, a transfer keypad including the characters identified by the image extraction character information about the second newest image (1) with K=2 of the Y application with L=2 is displayed.

Thereafter, when the transfer keypad specifying key is selected, the value of L is incremented to 3. In this case, there is no character information about the second newest image with K=2 of the Y application with L=3, and thus, the value of L returns to 1 and the value of K is incremented to 3. In this case, a transfer keypad including the characters identified by the image extraction character information about the third newest image (1) with K=3 of the X application with L=1 is displayed.

As described above, according to the third embodiment, even when the transfer keypad specifying key is selected, the characters obtained from the same application do not become the transfer candidates continuously, and thus, the user's character transfer operation can be facilitated.

### Fourth Embodiment

In a fourth embodiment, the user can select which of the plurality of pieces of image extraction character information the transfer keypad to be displayed is based on.

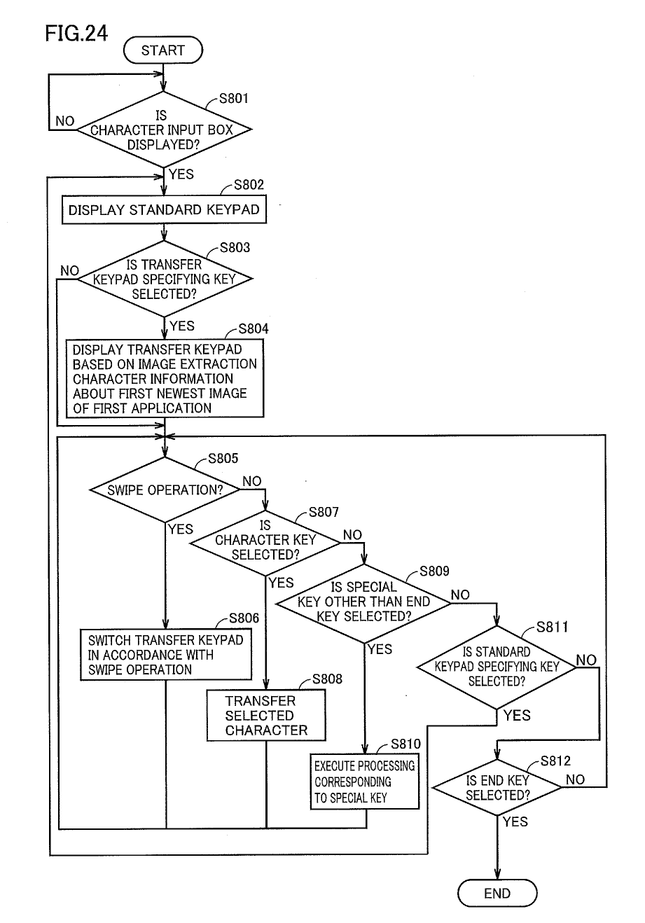

FIG. 24 is a flowchart showing a procedure of the character transfer processing in the fourth embodiment,

In step S801, if a character input box is displayed by a user's operation, the processing proceeds to step S802.

In step S802, character transfer unit 4 can display the standard keypad.

In step S803, if the user selects the transfer keypad specifying key, the processing proceeds to step S804.

In step S804, character transfer unit 4 can display a transfer keypad based on the character information about a first newest image of a first application. The transfer keypad includes one or more character keys (character key group) identified by the image extraction character information stored in memory 3 by character extraction unit 2, one or more special keys (special key group) and a swipe region.

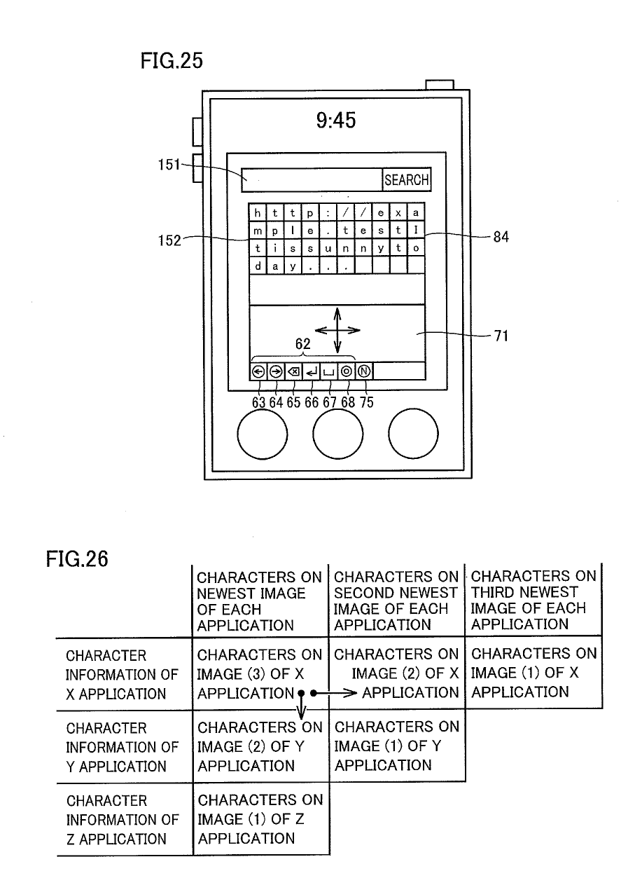

For example, when the image extraction character information shown in FIG. 20 is stored in memory 3, the transfer keypad including the characters identified by the image extraction character information about the newest image (3) of the X application is displayed. FIG. 25 is a diagram showing an example of the displayed transfer keypad.

This transfer keypad 84 includes character key group 152, special key group 62 and a swipe region 71.

In step S805, if the user performs a swipe operation on touch panel 5 in the swipeable region, the processing proceeds to step S806.

In step S806, character transfer unit 4 can switch the transfer keypad in accordance with the swipe operation.

FIG. 26 is a diagram showing a relationship between the swipe operation and the displayed characters.

In FIG. 26, for each application, the order of the images is defined as newest, second newest, third newest and the like in accordance with the order of character extraction. The images of the respective applications having the same character extraction order will be referred to as “images having the same extraction order”. Specifically, the image (3) of the X application, the image (2) of the Y application and the image (1) of the Z application are the images having the same extraction order. The image (2) of the X application and the image (1) of the Y application are the images having the same extraction order.

In accordance with the upward and downward swipe operation, character transfer unit 4 can display the transfer keypad including the characters on any one of the images belonging to the different applications and having the same extraction order.

In accordance with the rightward and leftward swipe operation, character transfer unit 4 can display the transfer keypad including the characters on any one of the plurality of images belonging to the same application.

As described above, the transfer keypad including the characters identified by the image extraction character information about the newest image (3) of the X application is first displayed. When the user performs the rightward swipe operation at this time, the transfer keypad including the characters identified by the image extraction character information about the second newest image (2) of the X application is displayed. When the user performs the downward swipe operation, the transfer keypad including the characters identified by the image extraction character information about the newest image (2) of the Y application is displayed.

When the user performs the upward or leftward swipe operation during display of the transfer keypad including the characters identified by the image extraction character information about the image (3) of the X application, there is no transfer keypad to be displayed, and thus, a message for notifying the user about that, e.g., a message of “no transfer keypad to be displayed”, may be displayed.

Not only when the transfer keypad including the characters identified by the image extraction character information about the image (3) of the X application is being displayed, but also when there is no transfer keypad to be displayed at the time of the user's swipe operation, the message for notifying the user about that may be displayed.

Similarly, when the user performs the rightward swipe operation during display of the transfer keypad including the characters identified by the image extraction character information about the image (2) of the X application, the transfer keypad including the characters identified by the image extraction character information about the third newest image (1) of the X application is displayed. When the user performs the leftward swipe operation, the transfer keypad including the characters identified by the image extraction character information about the newest image (3) of the X application is displayed. When the user performs the downward swipe operation, the transfer keypad including the characters identified by the image extraction character information about the second newest image (2) of the Y application is displayed.

Similarly, when the user performs the rightward swipe operation during display of the transfer keypad including the characters identified by the image extraction character information about the image (2) of the Y application, the transfer keypad including the characters identified by the image extraction character information about the second newest image (1) of the Y application is displayed. When the user performs the upward swipe operation, the transfer keypad including the characters identified by the image extraction character information about the newest image (3) of the X application is displayed. When the user performs the downward swipe operation, the transfer keypad including the characters identified by the image extraction character information about the newest image (1) of the Z application is displayed.

For the user who does not know how to operate, transfer keypad 84 shown in FIG. 25 may have a guide display key for displaying a guide of how to operate. In this case, when the user touches the guide display key, a relationship between the direction of the swipe operation and the type of the transfer keypad displayed when the user performs the swipe operation in this direction may be displayed.

In step S807, if a character key in the standard keypad or the transfer keypad is selected by the user's operation of tapping touch panel 5, the processing proceeds to step S808.

In step S808, character transfer unit 4 can transfer a character corresponding to the selected character key to the character input box. Thereafter, the processing returns to step S805.

In step S809, if a special key other than the end key in the standard keypad or the transfer keypad is selected by the user's operation of tapping touch panel 5, the processing proceeds to step S810.

In step S810, character transfer unit 4 executes the processing corresponding to the special key. Thereafter, the processing returns to step S805.

In step S811, if the standard keypad specifying key is selected by the user's input operation to touch panel 5, and specifically by the user's tapping operation, the processing returns to step S802.

In step S812, if the end key is selected by the user's operation of tapping touch panel 5, the processing ends.

As described above, according to the fourth embodiment, the user can switch the character key group included in the transfer keypad in accordance with the upward, downward, rightward, and leftward swipe operation. Therefore, the user's character transfer operation can be facilitated.

In the fourth embodiment, in accordance with the upward and downward swipe operation, the character transfer unit displays the transfer keypad including the characters on any one of the images belonging to the different applications and having the same extraction order, and in accordance with the rightward and leftward swipe operation, the character transfer unit displays the transfer keypad including the characters on any one of the plurality of images belonging to the same application. However, the present disclosure is not limited thereto.

For example, in accordance with the rightward and leftward swipe operation, the character transfer unit may display the transfer keypad including the characters on any one of the images belonging to the different applications and having the same extraction order, and in accordance with the upward and downward swipe operation, the character transfer unit may display the transfer keypad including the characters on any one of the plurality of images belonging to the same application.

In accordance with the swipe operation in the diagonal direction, the character transfer unit may display the transfer keypad including the characters on any one of the images having the different extraction orders and belonging to the different applications.

The direction of the swipe operation for displaying the transfer keypad including the characters on any one of the images belonging to the different applications and having the same extraction order, and the direction of the swipe operation for displaying the transfer keypad including the characters on any one of the plurality of images belonging to the same application are not limited to the directions described above. In another embodiment, these directions may be different directions, or may be settable as appropriate in order to make it easy for the user to operate.

Furthermore, the character transfer unit may switch the transfer keypad specifying key between display and non-display in accordance with a prescribed touch operation. In this case, the user can select, for example, whether to use the transfer keypad specifying key (when the transfer keypad specifying key is being displayed) or to use the swipe operation (when the transfer keypad specifying key is not being displayed) to switch the transfer keypad.

### Fifth Embodiment

In a fifth embodiment, one or a plurality of pieces of image extraction character information having the number of characters equal to or less than a prescribed number are created based on the displayed image.

When many characters are included in an image, the number of characters included in a transfer keypad increases. When the number of characters included in the transfer keypad is large, the function of scroll-displaying the characters included in the transfer keypad is required to display all characters. Instead of scroll display, in the fifth embodiment, when the number of characters included in the image exceeds the prescribed number, character extraction unit 2 can divide the characters included in the image into a plurality of groups of characters each having the number of characters equal to or less than the prescribed number, and store the characters in memory 3. Character transfer unit 4 can display a transfer keypad including one group of characters, and display a transfer keypad including another group of characters when the transfer keypad specifying key is selected.

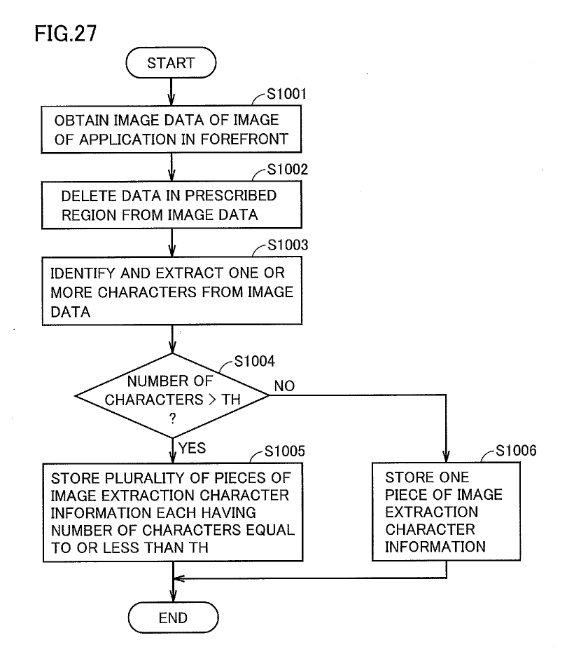

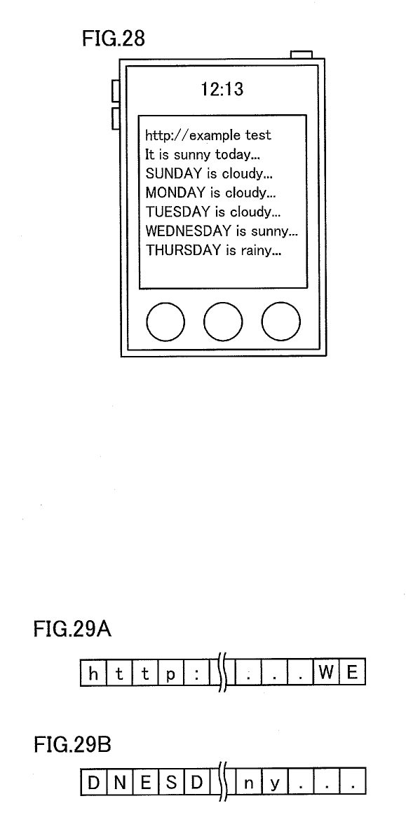

FIG. 27 is a flowchart showing a procedure of the character copy processing in the fifth embodiment. FIG. 28 and FIGS. 29A and 29B are diagrams for describing an example of the character copy processing in the fifth embodiment.

Referring to FIG. 27, in step S1001, character extraction unit 2 can obtain image data of an image displayed in the forefront.

In step S1002, character extraction unit 2 can delete data in a prescribed region from the obtained image data.

In step S1003, in accordance with the character recognition algorithm, character extraction unit 2 can identify and extract one or more characters included in the image data from which the data in the prescribed region was deleted.

In step S1004, if the number of extracted characters exceeds a threshold value (prescribed number) TH, the processing proceeds to step S1005. If the number of extracted characters is equal to or less than threshold value TH, the processing proceeds to step S1006.

In step S1005, character extraction unit 2 can divide the extracted characters into a plurality of groups of characters each having the number of characters equal to or less than threshold value TH, and create a plurality of pieces of image extraction character information each identifying one group of characters, and store the plurality of pieces of image extraction character information in memory 3.

In step S1006, character extraction unit 2 can store, in memory 3, one piece of image extraction character information having the number of extracted characters equal to or less than TH.

When an image is displayed on electronic device 1 as shown in FIG. 28, the number of extracted characters exceeds threshold value TH. Therefore, first image extraction character information and second image extraction character information each having the number of characters equal to or less than threshold value TH are created.

FIG. 29A is a diagram showing the characters identified by the first image extraction character information stored in memory 3. FIG. 29B is a diagram showing the characters identified by the second image extraction character information stored in memory 3.

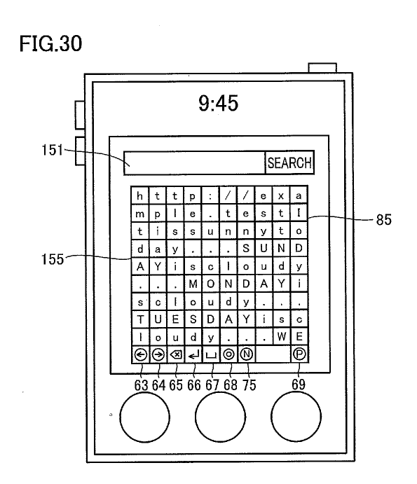

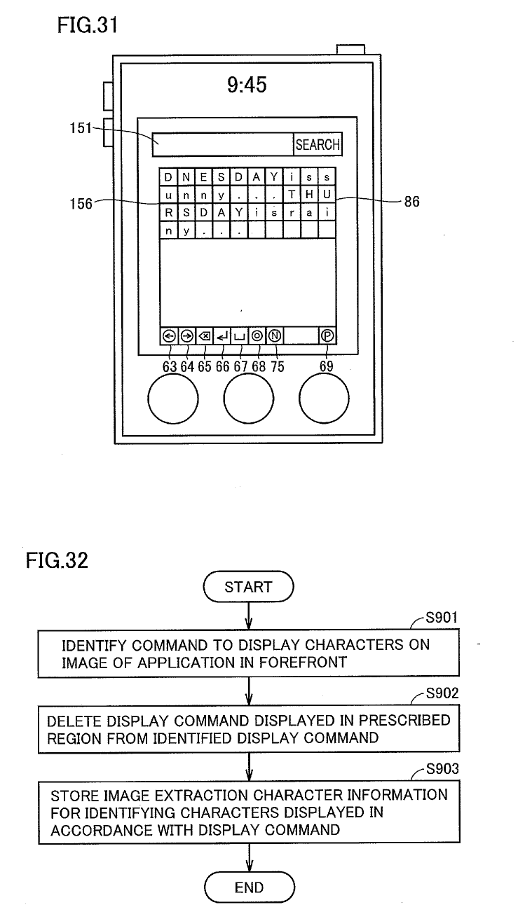

FIG. 30 is a diagram showing an example of a transfer keypad including the characters identified by the first image extraction character information at the time of character transferring. FIG. 31 is a diagram showing an example of a transfer keypad including the characters identified by the second image extraction character information at the time of character transferring. Switching between the transfer keypad shown in FIG. 30 and the transfer keypad shown in FIG. 31 is performed when transfer keypad specifying key 69 is selected.

As described above, in the fifth embodiment, when the number of characters included in one image exceeds the prescribed number, the characters included in the image are divided into the plurality of groups of characters each having the number of characters equal to or less than the prescribed number, and the transfer keypad including one group of characters is displayed, and the transfer keypad including another group of characters is displayed when the transfer keypad specifying key is selected. As a result, the user's character transfer operation is facilitated.

### Sixth Embodiment

In a sixth embodiment, the image extraction character information is created based on a command to display a character string, not based on the image data.

FIG. 32 is a flowchart showing a procedure of the character copy processing in the sixth embodiment.

Referring to FIG. 32, in step S901, character extraction unit 2 can identify a command to display one or more characters on an image displayed in the forefront. The command to display the characters includes a command to draw the characters, and character information (character code) for identifying the characters.

In step S902, character extraction unit 2 can delete a display command displayed in a prescribed region from the identified command to display one or more characters.

In step S903, character extraction unit 2 can store, in memory 3, image extraction character information for identifying the one or more characters displayed in accordance with the character display command from which the display command displayed in the prescribed region was deleted.

As described above, according to the sixth embodiment, the characters included in the displayed image are identified based on the command to display the characters, not based on the image data. Therefore, character extraction with a higher degree of accuracy is possible.

The embodiments described above are each not limited to being implemented alone. The embodiments described above can also be combined.

It should be understood that the embodiments disclosed herein are illustrative and non-restrictive in every respect. The scope of the present disclosure is defined by the terms of the claims, not the description above, and is intended to include any modifications within the scope and meaning equivalent to the terms of the claims.

1. An electronic device comprising:
a display;
a touch panel configured to accept a user's input operation;
a memory configured to store a character; and
at least one processor,
the at least one processor being configured to extract one or more characters included in an image presented on the display, without the user's input operation through the touch panel, and store the one or more characters in the memory,
the at least one processor being configured to present the one or more characters stored in the memory on the display as transfer candidates, and transfer, to a specified location, one or more characters selected based on the user's input operation through the touch panel.

2. The electronic device according to claim 1, wherein
the at least one processor is configured to obtain image data of the presented image, and identify one or more characters included in the image data in accordance with a character recognition algorithm.

3. The electronic device according to claim 2, wherein
the at least one processor is configured to delete a prescribed region from the obtained image data, and identify one or more characters included in the image data from which the prescribed region was deleted.

4. The electronic device according to claim 1, wherein
the at least one processor is configured to extract the one or more characters when a user does not operate the electronic device for a prescribed time period.

5. The electronic device according to claim 1, wherein
the at least one processor is configured to extract one or more characters included in an image presented by an application other than a prescribed application.

6. The electronic device according to claim 1, wherein
the at least one processor is configured to transfer, to the specified location, one or more characters located at a position of input to the touch panel.

7. The electronic device according to claim 1, wherein
the at least one processor is configured to present a blank character in addition to the one or more characters stored in the memory, and input the blank character to the specified location when a user selects the blank character.

8. The electronic device according to claim 1, wherein
the at least one processor is configured to transfer, to the specified location, a character string included from a start position to an end position of input to the touch panel.

9. The electronic device according to claim 1, wherein
the at least one processor is configured to, when transferring a first character string including one or more characters to the specified location and then further transferring a second character string including one or more characters to the specified location, input a blank character between the first character string and the second character string.

10. The electronic device according to claim 1, wherein
the memory is configured to store the one or more characters on a plurality of images extracted by the at least one processor, and
the at least one processor is configured to preferentially present, on the display as transfer candidates, one or more characters on a new image stored in the memory.

11. The electronic device according to claim 1, wherein
the memory is configured to store the one or more characters on a plurality of images extracted by the at least one processor, and the plurality of images comprise images of a plurality of applications,
the at least one processor is configured to switch to any one of the plurality of images in accordance with a user's switching instruction, one or more characters on the switched image being presented on the display, and
the at least one processor is configured to switch an extraction source application of the presented one or more characters, every time the user's switching instruction is provided.

12. The electronic device according to claim 1, wherein
the memory is configured to store the one or more characters on a plurality of images extracted by the at least one processor, and the plurality of images comprise images of a plurality of applications, and
the at least one processor is configured to switch to any one of the plurality of images in the memory in accordance with a user's swipe operation on the touch panel, one or more characters on the switched image being presented on the display.

13. The electronic device according to claim 12, wherein
the at least one processor is configured to present one or more characters included in any one of the images belonging to the different applications and having the same extraction order, in accordance with one of a swipe operation in a first direction and a swipe operation in a second direction different from the first direction, and
the at least one processor is configured to present, on the display, one or more characters included in any one of the plurality of images belonging to the same application, in accordance with the other of the swipe operation in the first direction and the swipe operation in the second direction.

14. The electronic device according to claim 1, wherein
the at least one processor is configured to, when the number of characters included in the image presented on the display exceeds a prescribed number, divide the extracted characters into a plurality of groups of characters each having the number of characters equal to or less than the prescribed number, and store the characters in the memory, and
the at least one processor is configured to present one group of characters in the memory on the display as transfer candidates, and present another group of characters in the memory on the display as transfer candidates in accordance with a user's switching instruction.
